(19) United States
(12) Patent Application Publication
(10) Pub. No.: US 2003/0133126 A1
(43) Pub. Date: Jul. 17, 2003

(54) Spectral reflectance for in-situ film characteristic measurements

(75) Inventors: Moshe Sarfaty, Cupertino, CA (US); Yuval Ben-Dov, Los Altos, CA (US)

Correspondence Address: APPLIED MATERIALS, INC., 2881 SCOTT BLVD. M/S 2061, SANTA CLARA, CA, 95050, US

(73) Assignee: APPLIED MATERIALS, INC., Santa Clara, CA (US)

(21) Appl. No.: 10/053,357

(22) Filed: Jan. 17, 2002

(51) Int. Cl. G01B 9/02

(52) U.S. Cl. 356/503

(57) ABSTRACT

A method and an apparatus to determine characteristics of a film on a substrate in a processing chamber. An example of a method in accordance with one embodiment of the present invention includes impinging optical radiation upon the film, sensing optical radiation reflected from the film to form spectral signals containing information concerning interference fringes, and obtaining thickness information of the film as a function of a periodicity of the interference fringes. The apparatus includes a detector in optical communication with the processing chamber to sense optical radiation generated by the plasma, and a spectrum analyzer in electrical communication with the optical detector. The spectrum analyzer resolves the spectral bands and produces information corresponding thereto. A processor is in electrical communication with the spectrum analyzer, and a memory is in electrical communication with the processor. The memory includes a computer-readable medium having a computer-readable program embodied therein that controls the system to carry out the method.

### BACKGROUND OF THE INVENTION

The present invention relates to monitoring of semiconductor processes. More particularly, the present invention relates to a method and apparatus to measure characteristics of a film during semiconductor processing.

The semiconductor processing industry continues to strive for larger production yields while increasing the uniformity of layers deposited on substrates having increasing larger surface areas. These same factors in combination with new materials also provide higher integration of circuits per unit area of the substrate. As circuit integration increases, the need for greater uniformity and process control regarding layer thickness rises. As a result, process diagnostics and control are important to determine the characteristics of films during processing. This has led to the development of many process control and diagnostic techniques to facilitate determination of film characteristics.

One prior art technique is optical endpoint detection technique. Optical endpoint detection ascertains a process endpoint by monitoring one or more narrow bands of optical emission from process plasmas. A drawback of this technique concerns the limited information regarding the characteristics of the processed films, such as only being able to determine the characteristics of the last film deposited.

The test wafer measurement is another prior art process control and diagnostic technique. Test wafer measure involves direct measurement of a film on a substrate undergoing processing. As a result, the test wafer measurement technique evaluates the last process step performed by examination of one or more test wafers that are processed within a group of production wafers. A drawback of this technique is that it does not provide means to measure film characteristics in situ and in real-time. This may result in the loss of a great number of processed wafers. Another drawback with this technique is that the test wafer measurement technique is, in some cases, destructive in nature, substantially reducing the operational life of the test wafer.

What is needed, therefore, is an improved technique to measure film characteristics during semiconductor processing.

### SUMMARY OF THE INVENTION

An exemplary embodiment of the present invention is directed to a method to determine characteristics of a film on a substrate in a processing chamber by impinging optical radiation upon the film, sensing optical radiation reflected from the film to form spectral signals containing information concerning interference fringes, and obtaining thickness information of the film as a function of a periodicity of the interference fringes. The apparatus includes a detector in optical communication with the processing chamber to sense optical radiation generated by the plasma, and a spectrum analyzer in electrical communication with the optical detector. The spectrum analyzer resolves the spectral bands and produces information corresponding thereto. A processor is in electrical communication with the spectrum analyzer, and a memory is in electrical communication with the processor. The memory includes a computer-readable medium having a computer-readable program embodied therein that controls the system to carry-out the method.

### BRIEF DESCRIPTION OF THE DRAWINGS

FIG. 1 is a simplified plan view of a plasma-based semiconductor processing system in accordance with the present invention;

FIG. 2 is a detailed cross-sectional view of a substrate shown above in FIG. 1;

FIG. 3 is a graphical representation of optical radiation levels reflected from a substrate and sensed by a detector using the processing system shown above in FIG. 1, in accordance with the present invention;

FIG. 4 is a graphical representation of a reciprocal pattern of the optical radiation levels shown above in FIG. 3, in accordance with the present invention;

FIG. 5 is a detailed cross-sectional view of the substrate shown above in FIG. 3, including a layer of photo-resist thereon;

FIG. 6 is a graphical representation reciprocal pattern of the optical radiation levels measured from the substrate shown above in FIG. 5, in accordance with the present invention;

FIG. 7 is a frequency domain representation of the reciprocal pattern shown above in FIG. 6, in accordance with the present invention;

FIG. 8 is a flow diagram showing a method for measuring the characteristics of a film in a semiconductor process;

FIG. 9 is a simplified plan view of a semiconductor processing system in accordance with an alternate embodiment of the present invention;

FIG. 10 is a detailed view of the semiconductor processing system, shown above in FIG. 1; and

FIG. 11 is a perspective view of a processing environment in which the processing chambers, shown above in FIGS. 1-3, may be employed.

### DETAILED DESCRIPTION OF THE INVENTION

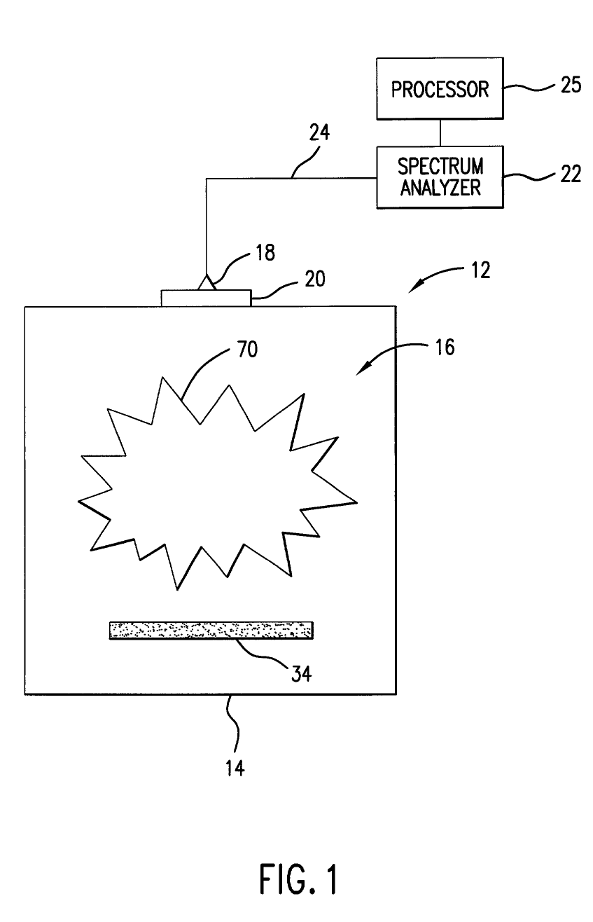

Referring to FIG. 1, a plasma-based semiconductor processing system 12 includes a housing 14 that defines a processing chamber 16. A lens assembly 18 is provided that is in optical communication with processing chamber 16 via a window 20 disposed in the housing 14. A spectrum analyzer 22 is in optical communication with the lens assembly 18 via a fiber-optic cable 24. A processor 25 is in data communication with the spectrum analyzer. The spectrum analyzer may include any known detector in the art, such as a charged-coupled-device (CCD), photo-multiplier tube and the like, and typically has a dispersive grating disposed between the detector and the window 20. Were a CCD detector employed, the dispersive grating would correspond each of the pixels associated with the CCD device to a set of wavelengths that differs from the set of wavelengths with which the remaining pixels of the CCD device correspond. The system 12 may be any plasma-based system known in the semiconductor art, e.g., plasma enhanced chemical vapor deposition system, sputter deposition system, etch system and the like. For purposes of the present discussion, the system 12 will be described as a plasma source chamber to, inter alia, implement etch processes.

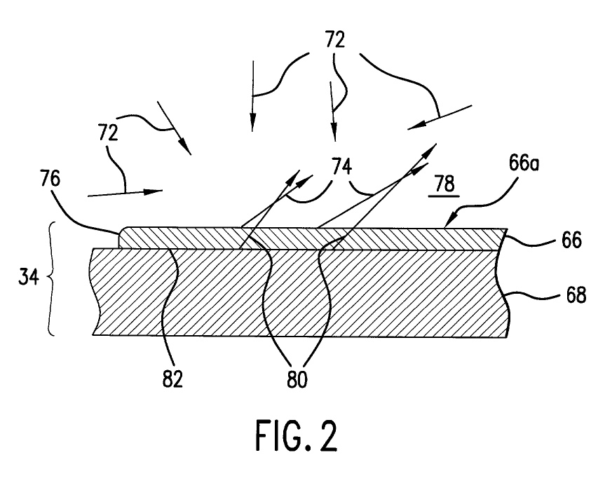

Referring to FIGS. 1 and 2, substrate 34 will typically include one or more films, shown as a film 66, disposed on a wafer 68. The wafer 68 may be formed from any material suitable for semiconductor processing. In this example, wafer 68 is formed from silicon. Similarly, film 66 may be formed from any material suitable for semiconductor processing. In the present example, film 66 is formed from silicon dioxide, SiO₂. Characteristics of film 66 are measured as a function of spectral emission of optical radiation reflected therefrom. In this example, the aforementioned optical radiation is produced by plasma 70, or external light source, discussed more fully below.

Specifically, optical radiation, shown by arrows 72, impinges upon substrate 34. A portion of the optical radiation, shown as rays 74, reflects from a first interface 76 defined by a film surface 66a and ambient 78. Another portion of the optical radiation, shown as rays 80, reflects from a second interface 82, defined by the interface of film 66 and wafer 68. The difference in the length of an optical path length, Λ, that is traveled by rays 74 and 80 is given by:

Λ=2n_{f}tcos θ (1)

where n_{f} is the refractive index of the film, t is thickness of film 66 in nm, and θ is the beam angle with the wafer surface. To ensure that θ is a small angle, lens assembly 18 is a collimating lens that is positioned to be disposed opposite of substrate 34 to sense cylindrical radiation reflecting from a subportion of substrate 34. The area of subportion is dependent upon several factors, such as length and numerical aperture of fiber 24. In one example, the area of subportion was 1 cm in diameter. In this manner, cylindrical light is collected by lens assembly 18 and collimated light is sensed by the detector in spectrum analyzer 22, ensuring that θ is very small. Assuming very small or 0° angle θ, equation (1) may be expressed in simplified form as follows:

Λ=2n_{f}t (2)

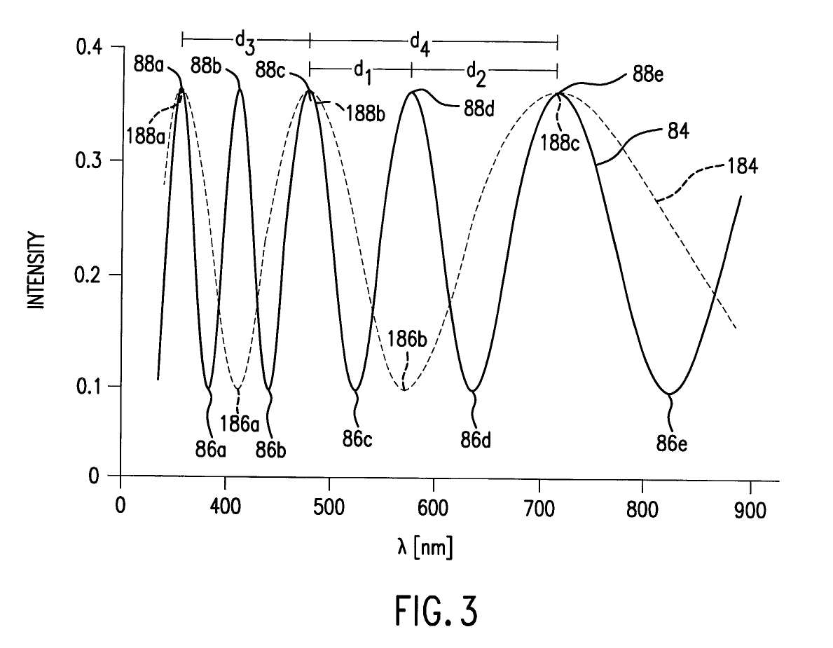

A relative phase shift, δ, between rays 74 and 80 may be defined as follows:

$$δ = {k}_{0} Λ = \frac{4 π {n}_{f} t}{λ} \pm π \qquad ( 3 )$$

where k₀=2π/Λ and λ is the wavelength of radiation produced by plasma 70. The interference of rays 74 with rays 80 forms an interference pattern, referred to as reflectance fringes, which are sensed by the detector in spectrum analyzer 22. The reflectance fringes, shown as 84 in FIG. 3, are obtained from emission spectra over a range of wavelengths.

Reflectance fringes 84 are characterized by a periodicity, defined by the distance between minima or maxima of reflectance fringes 84, discussed more fully below. For a fixed index of refraction and thickness of film 66, in this example 1000 Å, the periodicity was found to vary as a function of wavelength. One manner in which to determine the periodicity of reflectance fringes 84 is to identify minima 86a-e or maxima 88a-e among the reflectance fringes 84. For the case where δ has a value that is even multiples of π the thickness “tₘₓ”, in nm, of film 66 may be related to the position of maxima of fringes 84 as follows:

$${t}_{mx} = ( 2 m + 1 ) \frac{{λ}_{f}}{4} , \qquad ( 4 )$$

where m is an integer number associated with one of the fringes 84 of interest and Λ_{f} is the wavelength, in nm, of radiation in the film 66, i.e., Λ_{f}=λ/n_{f} wherein Λ is the wavelength of radiation produced by plasma 70 and n_{f} is the index of refraction of film 66. For the case where δ has a value that is odd multiples of π the thickness “tₘₙ”, in nm, of film 66 may be related to the position of minima of fringes 84 as follows:

$${t}_{mn} = m \frac{{λ}_{f}}{2} . \qquad ( 5 )$$

For a given thickness, t, the maxima and minima will occur at all wavelengths satisfying equations 4 and 5, respectively, when reflectance fringes are plotted as a function of λ. The width of the fringes in λ domain is proportional to λ. Thus, for shorter wavelengths the fringes are narrower and vice versa. For a fixed index of refraction and thickness of film 66, in this example 1000 Å, the distance between adjacent minima 86a-e or adjacent maxima 88a-e was found to vary as a function of wavelength. This is shown comparing distances d₁ and d₂. Distance d₁ is the distance between maxima 88c and 88d that correspond to the intensity measured at λ=490 nm and λ=580 nm, respectively. Distance d₂ is the distance between maxima 88d and 88e that correspond to the intensity measured at λ=580 nm and λ=725 nm, respectively. Comparing d₁ and d₂ it is seen that the distance between adjacent maxima varies as a function of wavelength. The same conclusion holds true concerning the distance between adjacent minima.

The distance between adjacent minima, or adjacent maxima, also varies as a function of thickness of film 66, as shown by reflectance fringes 184 in FIG. 3. Reflectance fringes 184 show intensity in arbitrary units for optical radiation reflected from film 66 having a thickness of approximately 500 Å. The distance between adjacent minima 186a-b and adjacent maxima 188a-c varies as a function of wavelength, as discussed above with respect to reflectance fringes 84. This is shown comparing distances d₃ and d₄. Distance d₃ is the distance between maxima 188a and 188b, which correspond to the intensity measured at λ=350 nm and λ=490 nm, respectively. Distance d₄ is the distance between maxima 188b and 188c, which correspond to the intensity measured at λ=490 nm and λ=725 nm, respectively. Comparing d₃ and d₄ it is seen that the distance between adjacent maxima depends on wavelength. In addition, however, it is also seen that comparing the combined distances d₁ and d₂ with the combined distances d₃ and d₄, we see that the distance between maxima also depends on the thickness of film 66.

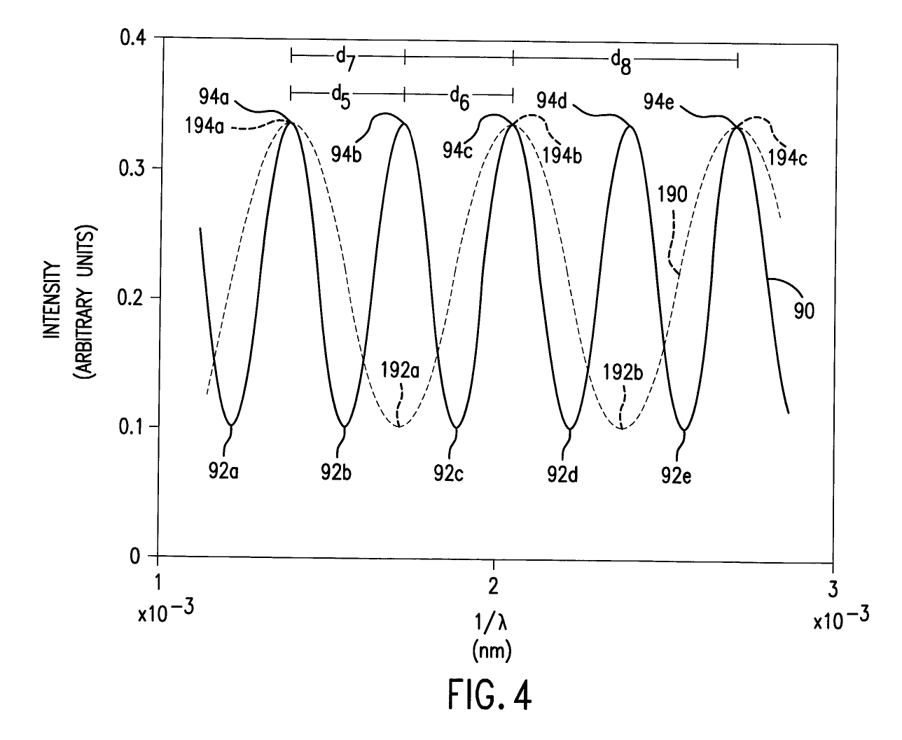

Referring to FIGS. 2, 3, and 4, to determine the thickness of the film 66 as a function of the periodicity of the reflectance fringes it is desirable to transform the data to a domain in which the distance between adjacent minima or adjacent maxima of reflectance fringes is independent of wavelength. It was found that this may be achieved by producing a reciprocal pattern 90 and 190 of the reflectance fringes 84 and 184 that is defined as 1/Λ. To that end, the data contained in reflectance patterns 84 and 184 is replotted to form reciprocal patterns 90 and 190, respectively. Specifically, the intensity values are replotted as a function of 1/Λ, instead of λ. Reciprocal pattern 90 corresponds to intensity measured from radiation reflecting off of film 66 having a thickness of approximately 1000 Å, and reciprocal pattern 190 corresponds to intensity measured from radiation reflecting off of film 66 having a thickness of approximately 500 Å. Assume that the distance, dₘₓₜ between adjacent maxima of periodic fringes may be defined as follows:

$${d}_{mxt} = \frac{( 2 m + 1 ) {λ}_{f}}{4} \qquad ( 6 )$$

where m is an integer, n_{f} is the index of refraction of film 66, and giving a periodicity of 2dn_{f} in the 1Λ domain.

As one could readily appreciate, the distance between adjacent pairs of minima 92a-e or adjacent pairs of maxima 94a-e of reciprocal pattern 90 is constant. This is shown by comparing distances d₅ and d₆, where d₅ is the distance between maxima 94a and 94b and distance d₆ is the distance between maxima 94b and 94c. Distances d₅ and d₆ are substantially equal. Similarly, the distance between adjacent minima or adjacent maxima in reciprocal pattern 190 are substantially constant. This is shown by comparing distances d₇ and d₈, where d₇ is the distance between maxima 194a and 194b and distance d₈ is the distance between maxima 194b and 194c. The difference in the distance between adjacent minima or adjacent maxima varies only as a function of film thickness, which can be shown by comparing d₇ or d₈ with d₅ or d₆. As shown, the thinner film 66 becomes, the greater the distance between adjacent minima or adjacent maxima. Thus, assuming a substantially constant index of refraction for film 66, characteristics of the film, such as thickness, may be measured as a function of the distance between adjacent minima or adjacent maxima of interference fringes produced by optical radiation reflecting from substrate 34 employing the reciprocal patterns 90 and 190. It should be noted that identifying maxima or minima and determining the distance between adjacent minima or adjacent maxima may be done using any mathematical technique known in the art. The thickness may then be given as the distance between adjacent minima or adjacent maxima, of interference fringes multiplied by two times the refractive index of film 66. However in the present example, the reciprocal pattern 190 is mapped into the frequency domain employing a Fast Fourier Transform (FFT), discussed more fully below.

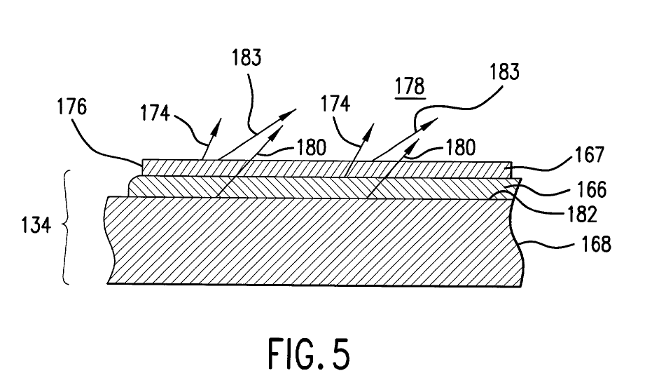

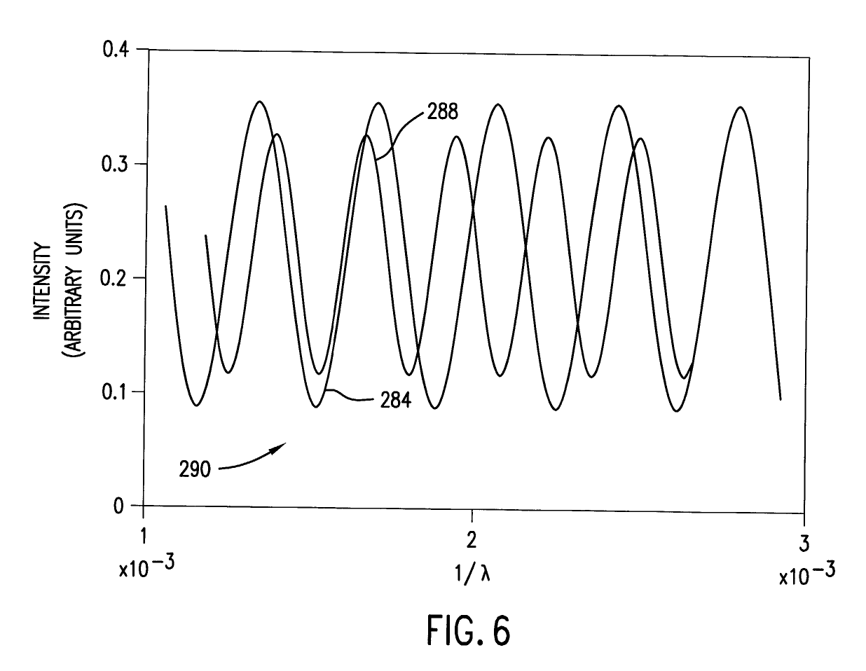

Referring to FIG. 5, difficulty arises when determining the thickness of a layer among a plurality of layers on a substrate 134. As shown, substrate 134 includes two layers. Layer 166 is a layer of SiO₂, and layer 167 is photo-resist. As discussed above, optical radiation reflects from various interfaces. The presence of layer 167 presents an additional interface from which optical radiation is reflected. For example, rays 174 represent optical radiation reflected from a first interface 176 defined between film 166 and photo-resist 167. Rays 180 represent optical radiation reflected from a second interface 182, defined by the interface of film 166 and wafer 168. A third interface is defined by the interface of photo-resist 167 with the ambient 178. Rays 183 are reflected from this interface. The interference of rays 174, 180 and 183 form an interference pattern from which a reciprocal pattern is formed, shown in FIG. 6 as 290. Interface pattern 290 includes curves 284 and 288, each of which contains characteristic information concerning either film 166 or photo-resist 167. Determining the characteristic information contained by one of the curves 284 and 288 may be computationally intensive. To that end, the reciprocal pattern 290 is transformed to a frequency domain. This may be done employing fourier analysis. In this example the reciprocal pattern is transformed into the frequency domain employing a Fast Fourier Transform (FFT).

Referring to FIGS. 5, 6, and 7, the FFT of reciprocal pattern 290 includes a series of peaks shown as 96 and 98 having differing amplitudes and ranges of frequencies associated therewith. As shown the amplitude of peak 96 is much less than the amplitude of peak 98. With a priori knowledge it may be determined which peak corresponds to which film, as well as certain characteristics of the film. In the present example it is known that photo-resist 167 has a greater area exposed to plasma 70, compared to film 166. It becomes evident that the peak with the greater amplitude, in this example peak 98, contains information concerning photo-resist 167. The remaining peak, peak 96 contains information concerning film 166. In addition, knowing the indices of refractions of film 166 and photo-resist 167, the thickness of the same may be derived knowing the center frequency of peaks 98 and 96, respectively. Thickness information may also be derived empirically.

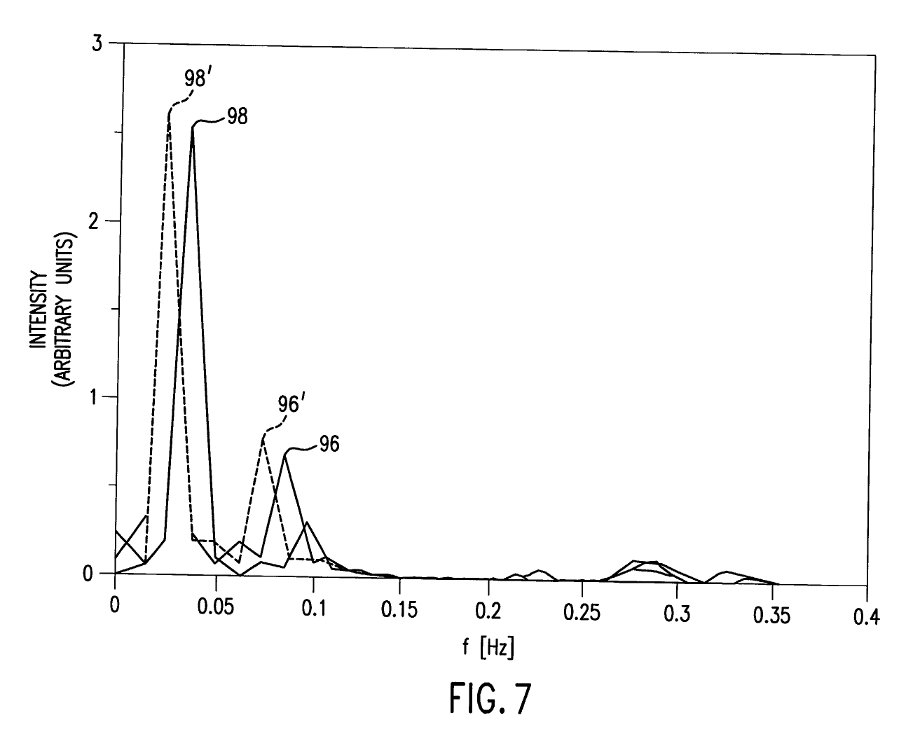

Additionally, observing variations in the peaks over time also facilitates process control of semiconductor processes. For example, during an etch process the center frequency of peak 98 was found to change over time at a greater rate than the change in the center frequency of peak 96. An example of this is shown in FIG. 7, where peak 98′ represents the thickness measurement of photo-resist 167 after being exposed to plasma 70 forty seconds after the thickness measurement represented by peak 98 occurred. The shift to the lower frequency represents a thinning of photo-resist 167. Peak 96′, however, superimposes peak 96, which indicates very little, if no change, in the thickness of film 166. From this information, information concerning plasma may be obtained and the characteristics of the same adjusted to selectively vary the etch rate of film 166 and photo-resist 167. For example, the characteristics of plasma 70 may be adjusted so that film 166 is etched at a faster rate than photo-resist 167. In addition, the etch rate exhibited by film 166 and photo-resist 167 may provide information from which diagnostic data concerning the processing system may be derived.

Referring to FIG. 5, as mentioned above, the exact thickness represented by the differing frequencies in the frequency domain may be determined empirically. In this manner, the thickness of either film 166 or photo-resist 167 may be determined as a function of frequency. Thickness measurements may be obtained for substrates having other layers of films thereon, in addition to layer 166 and photo-resist 167. As a result, an exemplary embodiment of the present invention includes a method for measuring characteristics of films on a substrate during a semiconductor process, such as etching.

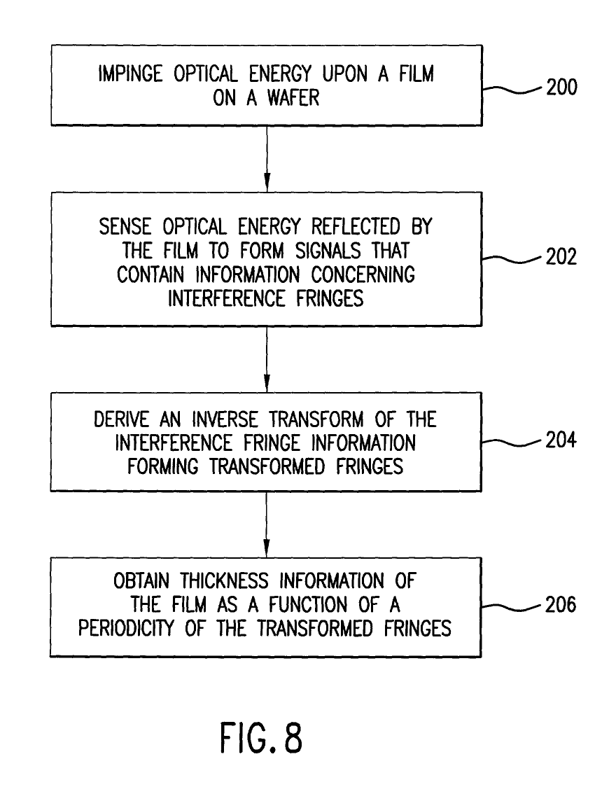

Referring now to FIG. 8, the method includes impinging optical radiation upon the film at step 200. At step 202, the spectrum analyzer senses optical radiation reflecting from the film to form signals that contain information concerning interference fringes. At step 204, the processor received the signals and derives an inverse transform of the interference fringe information, forming transformed fringes. At step 206, the processor 25 obtains thickness information of the film as a function of a periodicity of the transformed fringes.

The thickness information may be used advantageously in a feedback loop to control process conditions during processing. For example, in a deposition process the thickness information over time could be measured over time to determine the change in film thickness per unit time. This would facilitate control of the deposition rate in a deposition process or etch rate in an etch process.

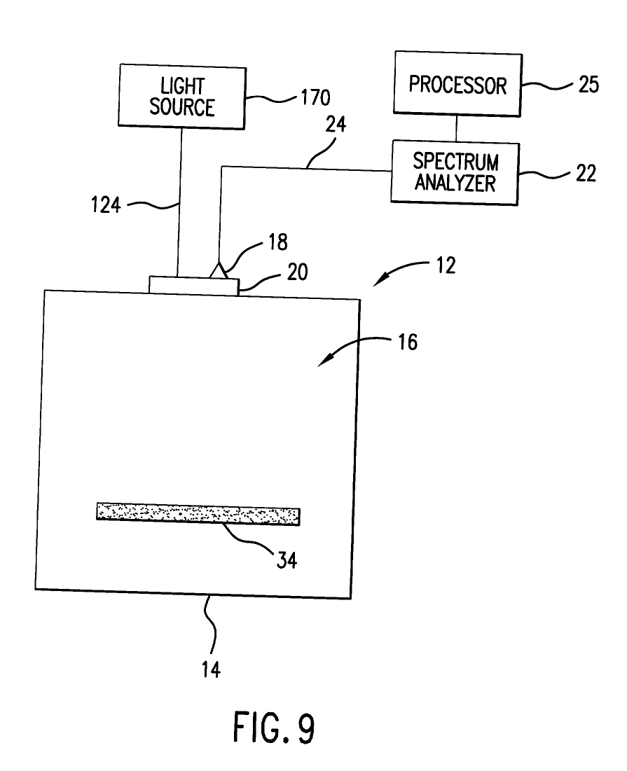

Although the foregoing invention has been discussed with respect to sensing optical radiation produced by plasma 70, it should be understood that a light source may be employed. To that end, a lamp, 170 may be placed in optical communication with processing chamber 16, via an optical fiber 124, as shown in FIG. 9.

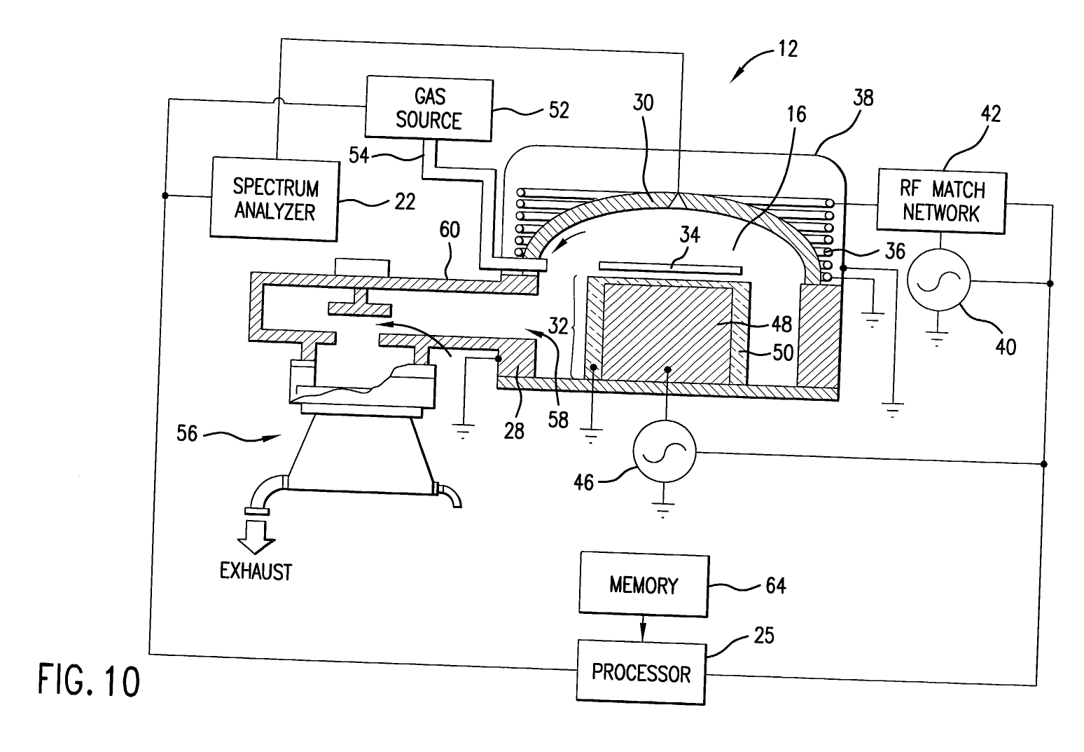

Referring to FIG. 10 in an exemplary semiconductor process in which the present invention may be employed etches wafer 34 in order to form, inter alia, trenches thereon. To that end, processing chamber 16 has a grounded, conductive, cylindrical sidewall 28 and a shaped dielectric ceiling 30, e.g., dome-like. Disposed within processing chamber 16 is a wafer pedestal 32 to support semiconductor wafer 34. A cylindrical inductor coil 36 surrounds dielectric ceiling 30 and, therefore, an upper portion of processing chamber 16. A grounded body 38 shields inductor coil 36. An RF generator 40 is in electrical communication with inductor coil 36 through a conventional active RF match network 42. A winding of coil inductor 36 furthest away from pedestal 32 is connected to the “hot” lead of RF generator 40, and the winding closest to pedestal 32 is grounded. An additional RF power supply or generator 46 is in electrical communication with an interior conductive portion 48 of pedestal 32. An exterior portion 50 of pedestal 32 is dielectric material.

One or more gas sources, shown as 52, are placed in fluid communication with processing chamber 16 through a feed line 54. A pumping system 56 controls the chamber pressure. To that end, sidewall 28 includes an exhaust port 58 that places pumping system 56 in fluid communication with processing chamber 16 via an exhaust conduit 60.

Etchant gas, such as NF₃, SF₆, SiF₄, Si₂F₆, and the like can be employed, either alone, or in combination with, a non-fluorine containing gas such as HBr, oxygen or both. The etchant gas exits gas source 52, traverses feed line 54 and enters processing chamber 16. The RF generators are activated to create a high-density plasma. To that end, in one example, RF generator 40 may provide up to about 3000 watts at 12.56 MHz. The RF generator 46 may supply up to 1000 watts at a frequency in the range of 400 kHz to 13.56 MHz to the interior conductor 48. The chamber pressure is typically in the range of 1 to 100 millitorr.

A processor 25, in data communication with a memory 64, controls the operation of the system 12. To that end, processor 25 is in data communication with the various components of the system, such as signal generators 40 and 46, RF match network 42, gas source 52, pump system 56, and spectrum analyzer 22. This is achieved by having the processor 25 operate on system control software that is stored in a memory 64. The computer program includes sets of instructions that dictate the timing, mixture of fluids, chamber pressure, chamber temperature, RF power levels, and other parameters of a particular process, discussed more fully below. The memory 64 may be any kind of memory, such as a hard disk drive, floppy disk drive, random access memory, read-only-memory, card rack or any combination thereof. The processor 25 may contain a single-board computer (SBC), analog and digital input/output boards, interface boards and stepper motor controller boards that may conform to the Versa Modular European (VME) standard that defines board, card cage, and connector dimensions and types. The VME standard also defines the bus structure as having a 16-bit data bus and a 24-bit address bus.

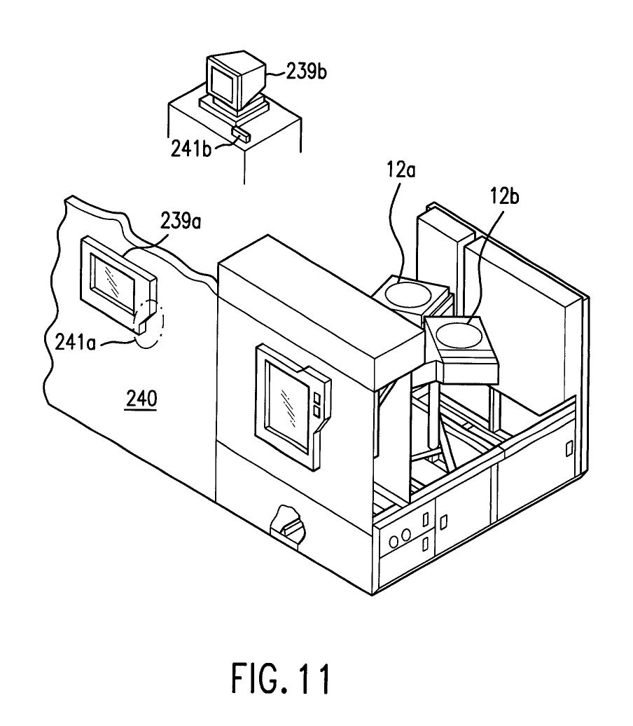

Referring to both FIGS. 10 and 11, the interface between a user and the processor 25 may be via a visual display. To that end, two monitors 239a and 239b may be employed. One monitor 239a may be mounted in a clean room wall 240 having one or more semiconductor processing systems 12a and 12b. The remaining monitor 239b may be mounted behind the wall 240 for service personnel. The monitors 239a and 239b may simultaneously display the same information. Communication with the processor 25 may be achieved with a light pen associated with each of the monitors 239a and 239b. For example, light pen 241a facilitates communication with the processor 25 through monitor 239a, and light pen 241b facilitates communication with the processor 25 through monitor 239b. A light sensor in the tip of the light pens 241a and 241b detects light emitted by CRT display in response to a user pointing the same to an area of the display screen. The touched area changes color, or a new menu or screen is displayed, confirming communication between the light pen and the display screen. Other devices, such as a keyboard, mouse, or other pointing or communication device may be used instead of or in addition to the light pens 241a and 241b to allow the user to communicate with the processor 25.

As discussed above, the computer program includes sets of instructions that dictate the timing, mixture of fluids, chamber pressure, chamber temperature, RF power levels, and other parameters of a particular process, as well as analyzing the information obtained by the spectrum analyzer 22, discussed more fully below. The computer program code may be written in any conventional computer readable programming language: for example, 68000 assembly language, C, C++, Pascal, Fortran, and the like. Suitable program code is entered into a single file, or multiple files, using a conventional text editor and stored or embodied in a computer-readable medium, such as a memory system of the computer. If the entered code text is in a high level language, the code is compiled, and the resultant compiler code is then linked with an object code of precompiled Windows® library routines. To execute the linked and compiled object code the system user invokes the object code, causing the computer system to load the code in memory. The processor 25 then reads and executes the code to perform the tasks identified in the program.

Although the invention has been described in terms of specific embodiments, one skilled in the art will recognize that various modification and improvements may be made. For example, the present invention may be employed to dynamically control process conditions in response to the spectra sensed by the spectra analyzer via feedback control. Therefore, the scope of the invention should not be based upon the foregoing description. Rather, the scope of the invention should be determined based upon the claims recited herein, including the full scope of equivalents thereof.

What is claimed is:

1. A method for determining characteristics of a film on a wafer in a processing chamber, said method comprising:
impinging optical radiation upon said film;
sensing optical radiation reflected by said film to form spectral signals containing information concerning interference fringes; and
obtaining thickness information of said film as a function of a periodicity of said interference fringes.

2. The method as recited in claim 1 wherein measuring said thickness further includes obtaining wavelength information from said spectral reflectance signals by mapping said spectral signals to a wavelength domain, defining wavelength domain information, and forming a reciprocal pattern of said wavelength domain information.

3. The method as recited in claim 1 further including mapping said thickness information into a frequency domain and determining a thickness of said film as a function of frequency.

4. The method as recited in claim 3 further including determining an etch rate of said film as a function of a change in said frequency during an interval of time.

5. The method as recited in claim 1 wherein sensing optical radiation reflected by said film further includes collecting, with a lens assembly, cylindrical radiation reflected from a subportion of said film.

6. The method as recited in claim 1 wherein sensing optical radiation reflected by said film further includes collecting, with a lens assembly, said reflected radiation and collimating said reflected radiation with said lens assembly.

7. The method as recited in claim 1 wherein said optical radiation reflecting from said wafer includes a first bundle of rays reflecting from a first interface and a second bundle of rays reflecting from a second interface, with said first interface being defined by a boundary of said film and said wafer, and said second interface being defined by a boundary of said film and an ambient, with said interference fringes being formed from interference of said first and second bundle of rays.

8. The method as recited in claim 1 wherein impinging optical radiation further includes exposing said wafer to plasma to produce optical radiation.

9. The method as recited in claim 1 wherein impinging optical radiation further includes exposing said wafer white light.

10. The method as recited in claim 1 wherein said wafer further includes a layer disposed between said wafer and said film, and further including mapping said thickness information into a frequency domain as a plurality of peaks, with a first of said plurality of peaks be centered about a first frequency and a second of said plurality of peaks being centered about a second frequency, with said first frequency corresponding to a thickness of said film and said second frequency corresponding to a thickness of said layer.

11. A method for determining characteristics of a film on a wafer, said method comprising:
impinging optical radiation upon said film;
sensing optical radiation reflected by said film to form spectral reflectance signals;
plotting said spectral reflectance signals as intensity versus wavelength, defining wavelength domain information;
producing a reciprocal pattern by replotting said wavelength domain information as intensity versus a reciprocal of said wavelength, with said reciprocal pattern being defined as 1/λ; and
obtaining frequency information associated with said reciprocal pattern by mapping said reciprocal pattern into a frequency domain and determining film characteristics as a function of said frequency information, said film characteristics including a thickness of said film.

12. The method as recited in claim 11 wherein said wafer further includes a layer disposed between said wafer and said film and obtaining frequency information further includes mapping said thickness information into a frequency domain as a plurality of peaks, with a first of said plurality of peaks being centered about a first frequency and a second of said plurality of peaks being centered about a second frequency, with said first frequency corresponding to a thickness of said film and said second frequency corresponding to a thickness of said layer.

13. The method as recited in claim 14 further including determining an etch rate of said film as a function of a change in said first frequency during an interval of time.

14. The method as recited in claim 13 wherein sensing optical radiation reflected by said film further includes collecting, with a lens assembly, cylindrical radiation reflected from a subportion of said film.

15. The method as recited in claim 14 wherein sensing optical radiation reflected by said film further includes collimating said cylindrical radiation with said lens assembly.

16. The method as recited in claim 15 wherein said optical radiation reflecting from said wafer includes a first bundle of rays reflecting from a first interface and a second bundle of rays reflecting from a second interface, with said first interface being defined by a boundary of said film and said wafer, and said second interface being defined by a boundary of said film and an ambient, with said interference fringes being formed from interference of said first and second bundle of rays.

17. The method as recited in claim 16 wherein impinging optical radiation further includes exposing said wafer white light.

18. The method as recited in claim 16 wherein impinging optical radiation further includes exposing said wafer to plasma to produce optical radiation.

19. An apparatus for determining characteristics of a film on a wafer, said apparatus comprising:
means for impinging optical radiation upon said wafer;
means for sensing optical radiation reflected by said film to form spectral signals containing information concerning interference fringes;
means for measuring characteristics of said film as a function of a periodicity of said interference fringes, said characteristics including thickness.

20. An apparatus for determining characteristics of a film on a wafer, said apparatus comprising:
a processing chamber to contain said wafer;
a system to generate optical radiation, with said optical radiation impinging upon said film;
a spectrum analyzer having a detector in optical communication with said processing chamber to sense optical radiation reflected by said film and resolve, from said optical radiation, spectral signals containing information concerning interference fringes;
a processor in electrical communication with said spectrum analyzer; and
a memory in electrical communication with said processor, said memory comprising a computer-readable medium having a computer-readable program embodied therein, said computer-readable program including a set of instructions to cause said processor to operate on said information and obtain thickness information of said film as a function of a periodicity of said interference fringes.

21. The apparatus as recited in claim 20 wherein said set of instructions further includes a subroutine to cause said processor to operate on said spectral signals to obtain wavelength information therefrom by mapping said spectral signals to a wavelength domain, defining wavelength domain information, and forming a reciprocal pattern of said wavelength information.

22. The apparatus as recited in claim 20 wherein said set of instructions further includes an additional subroutine to cause said processor to map said reciprocal pattern into a frequency domain and determine said thickness as a function of frequency.

23. The apparatus as recited in claim 20 wherein said set of instructions further includes a first subroutine to cause said processor to map said reciprocal pattern into a frequency domain and determine said thickness as a function of frequency and a second subroutine to determine an etch rate of said film as a function of a change in said frequency over an interval of time.

24. The apparatus as recited in claim 20 further including a plasma generation apparatus in data communication with said processor to generate a plasma within said process chamber, wherein said system to generate optical radiation includes a light source.

25. The apparatus as recited in claim 20 further including a lens assembly disposed between said processing chamber and said detector to collimate radiation reflected from said film.

26. The apparatus as recited in claim 20 further including a lens assembly disposed between said processing chamber and said detector to collect cylindrical radiation reflected from said film.

27. An apparatus for determining characteristics of a film on a wafer, said apparatus comprising:
a processing chamber to contain said wafer;
a system to generate optical radiation, with said optical radiation impinging upon said film;
a lens assembly disposed between said processing chamber and said detector to collect cylindrical radiation reflected from said film and collimate said cylindrical radiation, defining collimated radiation
a detector in optical communication with said lens assembly to sense said collimated radiation;
a spectrum analyzer having a detector in optical communication with said lens assembly to sense said collimated radiation and produce spectral signals having information concerning interference fringes, with said spectrum analyzer producing data corresponding to said interference fringes;
a processor in data communication with said spectrum analyzer; and
a memory in electrical communication with said processor, said memory comprising a computer-readable medium having a computer-readable program embodied therein, said computer-readable program including a set of instructions to cause said processor to operate on said data to obtain thickness information of said film.

28. The apparatus as recited in claim 27 wherein said set of instructions further includes a subroutine to cause said processor to operate on said data to obtain said thickness information as a function of a periodicity of said interference fringes.

29. The apparatus as recited in claim 28 wherein said sets of instructions further includes an additional subroutine to obtain wavelength information from said spectral signals by mapping said signals to a wavelength domain, defining wavelength domain information, and forming a reciprocal pattern of said wavelength information.

30. The apparatus as recited in claim 29 further including a second set of instructions to cause said processor to map said reciprocal pattern into a frequency domain and determine said thickness as a function of frequency.

31. The apparatus as recited in claim 30 wherein said second set of instructions further includes a first subroutine to determine an etch rate of said film as a function of a change in said frequency over an interval of time.
